(19) United States
(12) Patent Application Publication
(10) Pub. No.: US 2020/0313129 A1
(43) Pub. Date: Oct. 1, 2020

(54) BATTERY BLOCK

(71) Applicant: SANYO Electric Co., Ltd., Daito-shi, Osaka (JP)

(72) Inventors: Masato Koutari, Hyogo (JP); Takuya Egashira, Hyogo (JP); Hiroshi Takata, Hyogo (JP); Shunsuke Yasui, Hyogo (JP)

(73) Assignee: SANYO Electric Co., Ltd., Daito-shi, Osaka (JP)

(21) Appl. No.: 16/311,027

(22) PCT Filed: May 9, 2017
(86) PCT No.: PCT/JP2017/017449

§ 371 Date: Dec. 18, 2018

(30) Foreign Application Priority Data
Jun. 30, 2016 (JP) 2016-130797

(51) Int. Cl. H01M 2/10; H01M 10/643; H01M 2/12

(52) U.S. Cl. CPC H01M 2/1077; H01M 10/643; H01M 2/1282; H01M 2/1276; H01M 2/1294

(57) ABSTRACT

A battery block is provided with: a plurality of cylindrical batteries of each of which the two ends are formed as positive and negative electrodes; and a lead plate which is connected to the electrodes of the cylindrical batteries. The cylindrical batteries are provided with battery cans having exhaust valves provided to bottom plates. Bottom surface electrodes for connecting the lead plate are provided to the bottom plates of the battery cans. Furthermore, ring-shaped thin-walled lines which break at a threshold pressure are provided in the bottom plates. The insides of the thin-walled lines form sets of the exhaust valves. The lead plate connected to the bottom surface electrodes has, provided in positions facing the exhaust valves, through holes having an internal shape through which the exhaust valves which have separated from the bottom plates can pass.

### TECHNICAL FIELD

The present invention relates to a battery block in which a plurality of cylindrical batteries are connected by a lead plate. Especially the present invention relates to the battery block described in the following. In this battery block, cylindrical batteries are connected by a lead plate. These cylindrical batteries each have an exhaust valve which breaks when the inner pressure increases abnormally.

### BACKGROUND ART

In a battery block which provides power to a driving motor of a hybrid car or an electric vehicle, the output and the charge and discharge capacity are enlarged by connecting a lot of secondary batteries in series or parallel. In order that this type of the battery block realizes or secures a high safety,

the battery block is provided with an exhaust valve. This exhaust valve prevents harmful effects by rupture of the battery can. Since the exhaust valve opens when the inner pressure becomes higher than a threshold pressure, the rupture of the battery can is prevented. Further, the exhaust valve is connected to an exhaust duct, and high-temperature and high-pressure gas which is emitted in a state of the open valve, is safely exhausted outside the battery block. In order to realize this, a secondary battery is developed where a sealing plate has an exhaust valve (refer to Patent Literature 1).

As shown in a sectional view of FIG. 6, this secondary battery is provided with exhaust valves 83 at sealing plate 82 of cylindrical battery 81. In this cylindrical battery 81 of this figure, two sheets of metal plates are stacked as sealing plate 82, coil spring 85 is disposed inside projecting electrode 84 which upper metal plate 82A includes, and valve member 86 urged by this coil spring 85, is resiliently pressed to the surface of lower metal plate 82B. Lower metal plate 82B is provided with through hole 87, and valve member 86 is pressed so as to close this through hole 87. This secondary battery is in a state of closed valve where valve member 86 is pressed to lower metal plate 82B, when the inner pressure of the battery case is lower than the threshold pressure. When the inner pressure becomes higher than the threshold pressure, exhaust valves 83 is opened with valve member 86 pushed up. When exhaust valve 83 is opened, the high-temperature and high-pressure gas which passes through hole 87 is exhausted outside from small hole 88 disposed at projecting electrode 84. Therefore, there is a trouble that the high-temperature and high-pressure gas cannot be exhausted quickly.

In order to resolve this trouble, a secondary battery is developed where a exhaust valve is provided at a bottom plate of an outer can (refer to Patent Literature 2). The bottom plate of this secondary battery is shown in FIGS. 7 and 8. In each of bottom plates 91, 92 of these figures, thin-walled line 94 having a ring shape is disposed, and thereby exhaust valve 93 is made at the inside of thin-walled line 94. In each of the bottom plates 91, 92, two pieces of exhaust valves 93 are provided. In the bottom plate 91 of FIG. 7, it is difficult that two pieces of exhaust valves 93 are simultaneously opened. That is the reason why, once one of exhaust valves 93 is opened, the other of exhaust valves 93 is not opened as the inner pressure decreases. When neither of exhaust valves 93 is opened, and the opening area of exhaust valve 93 is small. Then, the inner gas cannot be quickly exhausted. In order to resolve this trouble, in bottom plate 92 of FIG. 8, two pieces of exhaust valves 93 are connected by inner tab 95 having high hardness. Then, by using the movement of opening the one of exhaust valves 93, the other of exhaust valves 93 can be opened and broken. In this bottom plate 92, both of exhaust valves 93 can be simultaneously opened. However, inner tab 95 connecting exhaust valves 93 restricts opening locations of the valves. That is the reason why, inner tab 95 is caught by rib 96 partitioning two pieces of exhaust valves 93, and thereby exhaust valve 93 cannot be opened sufficiently apart from bottom plate 92. Therefore, there is a fault that the inner gas cannot be quickly exhausted with both of exhaust valves 93 opened widely.

### CITATION LIST

### Patent Literature

Patent Literature 1: Unexamined Japanese Patent Publication No. 2007-5075

Patent Literature 2: Unexamined Japanese Patent Publication No. 2016-100273

### SUMMARY OF THE INVENTION

### Technical Problem

In a battery block including a lot of secondary batteries, in a state where the exhaust valve is opened by thermal runaway of any one of the secondary batteries, it is very important that the thermal runaway does not cause another thermal runaway of an adjacent secondary battery. That is the reason why, when the thermal runaways are induced in a plurality of secondary batteries, the thermal runaways spread into the whole of the battery block. For example, when the exhaust valve is opened due to the thermal runaway of the lithium ion secondary battery, the extremely high-temperature and high-pressure gas of several hundreds degrees or more is emitted momentarily. Therefore, it is very important to surely prevent the thermal runaway from being induced. It is also very important to momentarily open the exhaust valve largely, and to quickly exhaust the high-temperature and high-pressure gas emitted through the opened exhaust valve outside from the exhaust duct.

Exhaust valves 93 disposed at bottom plates 91, 92 shown in FIGS. 7 and 8, can exhaust the inner gas more smoothly than exhaust valve 83 of sealing plate 82 shown in FIG. 6. It is very important to exhaust more quickly the inner gas, also through exhaust valves 93 of bottom plates 91, 92. That is the reason why the quick exhaust of the inner gas can improve the safety of the battery block.

The present invention is developed for achieving the above-mentioned purpose, and one of objects of the present invention is to supply a battery block which achieves very smooth discharge of internal gas from open exhaust valves, effectively inhibits the triggering of thermal runaway, and achieves a high degree of safety.

### Solution to Problem and Advantageous Effects of Invention

A battery block of one aspect of the present invention, includes: a plurality of cylindrical batteries (1) of each of which the two ends are formed as positive and negative electrodes (15) which are each connected to lead plates (3); and lead plates (3) which are connected to the electrodes (15) of the cylindrical batteries (1). The cylindrical batteries (1) are provided with battery cans (10) having exhaust valves (16) provided to bottom plates (12). Bottom surface electrodes (15B) for connecting the lead plates (3) are provided to the bottom plates (12) of the battery cans (10). Furthermore, ring-shaped thin-walled lines (17) which break at a threshold pressure are provided in the bottom plates (12). The insides of the thin-walled lines (17) form sets of the exhaust valves (16). The one of the lead plates (3) connected to each of the bottom surface electrodes (15B) has, provided in a position facing each of the exhaust valves (16), a through hole (32) of an internal shape through which each of the exhaust valves (16) which separates from the bottom plates (12), passes. The bottom surface electrodes (15B) are provided further outside than the thin-walled lines (17). The lead plate (3) is connected to the bottom surface electrodes (15B).

The above-mentioned battery block which achieves very smooth discharge of internal gas from open exhaust valves, effectively inhibits the triggering of thermal runaway, and secures a high degree of safety. That derives from the following. In the battery block, the sets of the exhaust valves are disposed at the bottom plates. Then, the lead plate connected to each of the bottom surface electrodes has, provided in a position facing each of the exhaust valves, a through hole of an internal shape through which each of the exhaust valves which separates from the bottom plates, passes. Then, in the bottom plate, the bottom surface electrodes are provided further outside than the thin-walled lines. Then, the lead plate is connected to the bottom surface electrodes. Especially, in the above-mentioned battery block, the lead plate has the through hole through which the separated exhaust valve passes. Since the lead plate is not connected to the exhaust valve separated from the bottom plate in the opened valve state, the separated exhaust valve passes through the through hole of the lead plate, and is surely exhausted outside, without being restricted by the lead plate. Further, since one set of the exhaust valve is disposed at the bottom plate, compared with the conventional battery blocks shown in FIGS. 7 and 8, in the above-mentioned battery block, it is not necessary that the inner tab having high hardness is connected to simultaneously open the plurality of exhaust valves. In the above-mentioned battery block, it is not necessary that the partitioning rib is disposed between the plurality of exhaust valves. In the above-mentioned battery block, the inner tab having high hardness does not restrict the opening level of the exhaust valve, and further the partitioning rib does not restrict the opening level of the exhaust valve. Therefore, in the above-mentioned battery block, when the inner pressure of the secondary battery becomes more than the threshold pressure, the thin-walled line is broken, and the exhaust valve is opened and separated from the bottom plate. As shown by the chain line in FIG. 3, the separated exhaust valve (16) which is not connected to the lead plate, passes through the through hole (32) of the lead plate (3), and is surely exhausted outside. Thus, the opening level of the exhaust valve separated from the bottom plate is large, and the inner gas can be smoothly exhausted. The exhaust valve which is separated from the bottom plate by opening the valve, is moved to an exhaust duct. The inner gas smoothly flows from the widely opened exhaust port to the exhaust duct, and is quickly exhausted. Therefore, in the above-mentioned battery block, when the exhaust valve is opened due to the thermal runaway of any one of cylindrical batteries, the inner gas of this cylindrical battery is momentarily exhausted. Thus, this effectively prevents that the thermal runaway causes another thermal runaway of an adjacent cylindrical battery due to the delay in the exhaust of the inner gas, to remarkably improve the safety of the battery block.

Further, in the above-mentioned battery block, the bottom surface electrode is disposed at the outside of the exhaust valve, and the lead plate is connected to this bottom surface electrode. Therefore, the lead plate is connected to the bottom plate even in the valve opening state. In the battery block, the inner tab is not separated from the bottom plate in the valve opening state, and a state can be held where the spiral electrode assembly is connected to the electrode of the cylindrical battery in the valve opening state. Therefore, in this battery block, a fuse as the protection element is connected in series to each of the cylindrical batteries, and by making a fusing current flow through the cylindrical battery having the opened valve, the fuse connected in series to the cylindrical battery can be fused. Thus, the cylindrical battery having the opened valve is separated from the other batteries, and the other batteries not having the opened valve are safely used in charge and discharge.

In the battery block of the present invention,
the one of the lead plates (3) connected to each of the bottom surface electrodes (15B), is connected to each of the bottom surface electrodes (15B) through a resilient arm (31) of which one end is connected to main body portion (30) of the one of the lead plates (3), and
the resilient arm (31) has an arch shape which is elongated along an inner edge of the through hole (32).

In the above-mentioned battery block, the lead plate includes the resilient arm, the lead plate is connected to the bottom surface electrode through the resilient arm. Therefore, the stress of the lead plate caused by the relative position shift to the cylindrical battery, can be absorbed by the resilient arm, and the lead plate can be stably connected to the bottom plate for a long time. Further, in a state where the lead plate is ultrasonic-welded to the bottom plate, by resiliently deforming the resilient arm, the resilient arm can be connected to the bottom surface electrode efficiently. Additionally, at the time of ultrasonic-welding the lead plate, the damage on the thin-walled line of the bottom plate by the ultrasonic-vibration can be decreased. Then, this prevents the threshold pressure of the exhaust valve from being shifted due to the damage of the thin-walled line, after connecting the lead plate. Furthermore, the resilient arm has an arch shape which is elongated along an inner edge of the through hole. Therefore, the resilient arm can be disposed in a narrow area, and can be resiliently deformed smoothly, and the resilient arm can be surely stably connected to the bottom surface electrode, and this effectively prevents the damage of the thin-walled line.

In the battery block of the present invention,
the one of the lead plates (3) includes a pair of resilient arms (31) which are disposed at both sides of the through hole (32),
the pair of resilient arms (31) include connecting portion (33) which connects end portions on the side opposite to a connecting end where the pair of resilient arms (31) are connected to main body portion (30) of the one of the lead plates (3), and
the connecting portion (33) is connected to each of the bottom surface electrodes (15B).

In the above-mentioned battery block, the pair of resilient arms are connected to the bottom surface electrode. Therefore, the resilient arms are made of thin metal boards which are easily resiliently deformed, but the resistance of the resilient arms is decreased, and the resistance loss by large current can be decreased. Since the resilient arms are easily resiliently deformed, the relative position shift of the cylindrical battery connected to the lead plate, can be reasonably absorbed, and the connecting portion of the bottom surface electrode and the resilient arms can be protected. Further, as the tip portion of the resilient arms is efficiently ultrasonic-vibrated, the ultrasonic-welded lead plate can be stably connected to the bottom surface electrode. Additionally, as the tip portion of the resilient arms is efficiently ultrasonic-vibrated, the output power of the ultrasonic vibrator can be made small, and the resilient arms can be surely connected to the bottom surface electrode. Therefore, the damage of thin-walled line in the ultrasonic-welding process connecting the lead plate to the bottom surface electrode can be decreased. This prevents the threshold pressure of the exhaust valve from being shifted, and the lead plate can be connected to the bottom surface electrode.

In the battery block of the present invention,
a cylindrical portion of each of the battery cans (10) and a peripheral edge of each of the bottom plates (12) are covered with an insulation tube (23),
each of the bottom surface electrodes (15B) is disposed between the insulation tube (23) and each of the thin-walled lines (17). This battery block is characterized in that the adjacent cylindrical batteries can be surely insulated each other and disposed.

In the battery block of the present invention,
the one of the lead plates (3) is connected to each of the bottom surface electrodes (15B) by ultrasonic-welding. In the battery block, even though the battery block and the lead plate are different kinds of metals, the lead plate can be stably connected to the bottom surface electrodes.

In this battery block of the present invention,
an inner tab (22) which is connected to an electrode plate (21) housed in each of the battery cans (10), is welded to an inner surface of each of the exhaust valves (16),
the inner tab (22) is a metal plate thinner than each of the bottom plates (12) from which each of the exhaust valves (16) separates in a state of a broken valve. In this battery block, the inner tab is broken and separated in the valve opening state, and the opened valve can be surely separated from the bottom plate.

In the battery block of the present invention,
the one of the lead plates (3) connected to each of the bottom surface electrodes (15B), in a metal plate having a thickness of 100 μm or more to 500 μm or less,
the metal plate is made of any one of aluminum, copper, nickel, iron, or an alloy of these metals.

In the battery block of the present invention,
a current collecting plate (5) is connected to the one of the lead plates (3) connected to each of the bottom surface electrodes (15B). In this battery block, the lead plate is stably surely connected to the cylindrical batteries, and the adjacent cylindrical batteries are connected by the current collecting plate having a low resistance, and the resistance loss of the connecting lead can be decreased.

In the battery block of the present invention,
each of the cylindrical batteries (1) is a nonaqueous secondary battery of a lithium ion secondary battery or the like.

### BRIEF DESCRIPTION OF DRAWINGS

FIG. 1 is a perspective view of a battery block according to one exemplary embodiment of the present invention.

FIG. 2 is an exploded perspective view of the battery block illustrated in FIG. 1.

FIG. 3 is a sectional view of the battery block illustrated in FIG. 1 taken along line III-Ill.

FIG. 4 is an enlarged bottom surface view showing a state where a lead plate is connected to a bottom plate of a cylindrical battery.

FIG. 5 is a perspective view of the cylindrical battery and the lead plate as viewed from the bottom surface.

FIG. 6 is an enlarged sectional view of a conventional secondary battery.

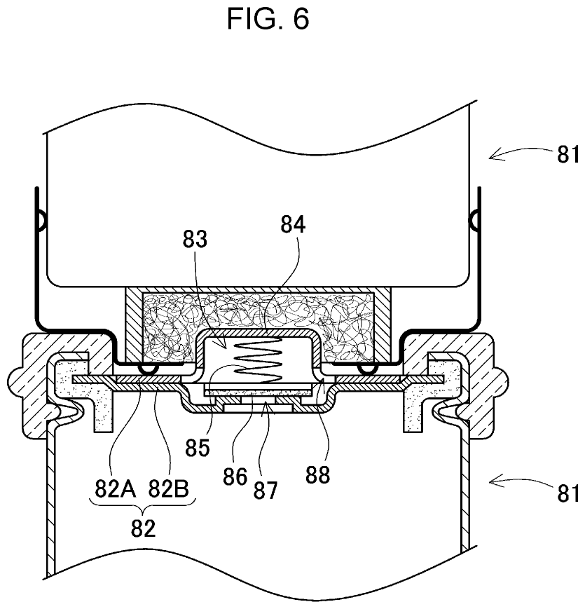

FIG. 7 is a plan view of a bottom plate of another conventional secondary battery.

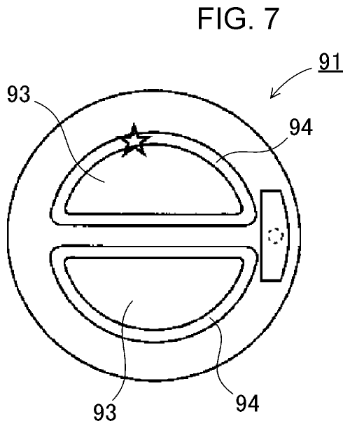

FIG. 8 is a plan view of a bottom plate of a further other conventional secondary battery.

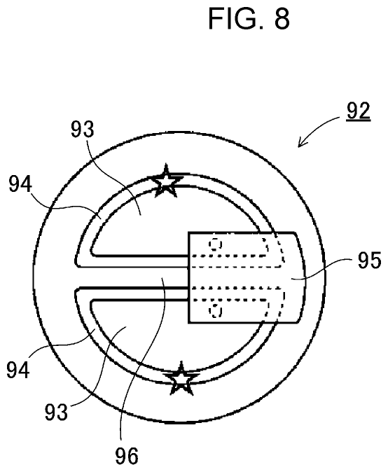

### DESCRIPTION OF EMBODIMENTS

Exemplary embodiments and examples of the present invention have been described with reference to the drawings. However, the exemplary embodiment described below shows a battery block for embodying the technical ideas of the present invention. The battery block of the present invention is not limited to the following. Further, in the present description, components shown in the scope of claims are not limited to the components of the exemplary embodiment.

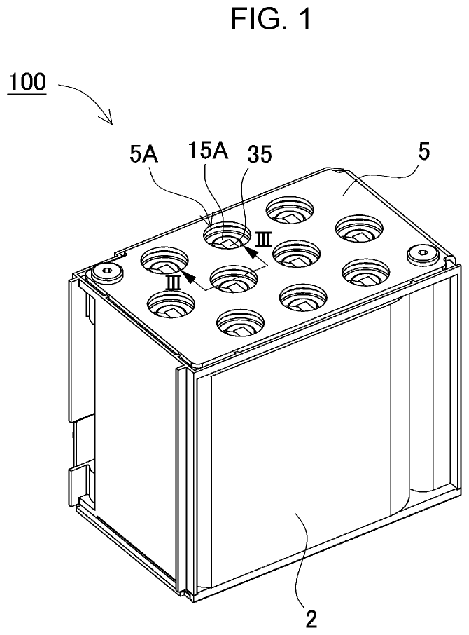

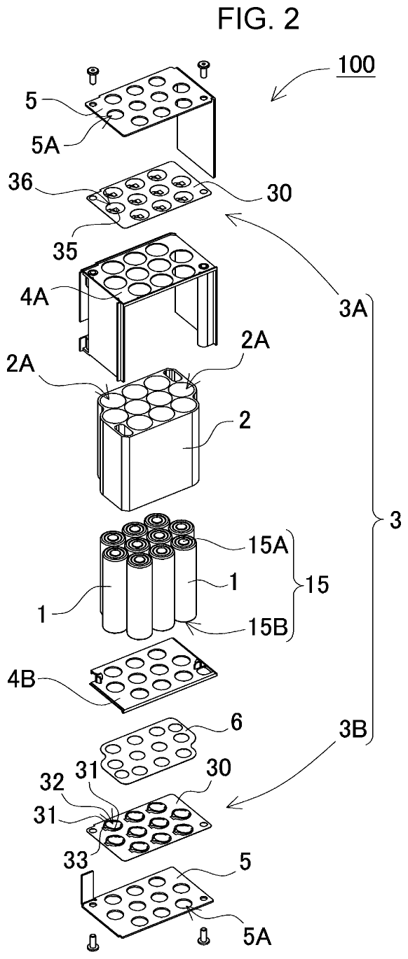

Battery block 100 shown in FIGS. 1 and 2, includes a plurality of cylindrical batteries 1. In battery block 100, the current can be enlarged by connecting cylindrical batteries 1 in parallel, and the output voltage can be increased by connecting cylindrical batteries 1 in series. The charge and discharge capacity can be enlarged by increasing the number of connected cylindrical batteries 1. Therefore, in battery block 100, the plurality of cylindrical batteries 1 are connected in series or parallel, in order to obtain the optimal output voltage, output current, and charge and discharge capacity for the use. Battery block 100 of the present invention is mainly used as a power source which provides power to a driving motor of electric vehicles, for example, such as, hybrid cars, plug-in hybrid cars, or electric cars. In the use other than electric vehicles, battery block 100 can be used as the use requiring a large output, for example, a power source of electric power storage use.

Battery block 100 shown in the exploded perspective view of FIG. 2, includes: the plurality of cylindrical batteries 1; battery holder 2 which disposes each of cylindrical batteries 1 in each of fixed locations; insulation holders 4A, 4B which cover both-ends surfaces of battery holder 2; lead plates 3 which are connected to positive and negative electrodes 15 of cylindrical batteries 1; current collecting plates 5 which are stacked and connected to lead plates 3; and insulation sheet 6 which is disposed between insulation holders 4A and lead plate 3. In battery block 100, the plurality of cylindrical batteries 1 are connected in parallel by lead plates 3. In battery block 100, all of cylindrical batteries 1 are connected in parallel. However, in battery block 100 of the present invention, cylindrical batteries 1 can be connected in parallel, or in series and parallel.

In battery block 100 of FIG. 2, battery holder 2 disposes each of cylindrical batteries 1 in each of the fixed locations. Battery holder 2 includes a plurality of holding holes 2A which penetrate battery holder 2 so as to reach both surfaces. Cylindrical batteries 1 are inserted into these holding holes 2A, to dispose cylindrical batteries 1 in each of the fixed locations. Since all of cylindrical batteries 1 in battery block 100 of the figures are connected in parallel, all of cylindrical batteries 1 are inserted into holding holes 2A in the same direction, to dispose cylindrical batteries 1 in each of the fixed locations.

Cylindrical battery 1 is a nonaqueous secondary battery of a lithium ion secondary battery. As the lithium ion secondary battery has a large capacity to a weight, battery block 100 having cylindrical batteries 1 of lithium ion secondary batteries, can be reduced in weight, and can increase the charge and discharge capacity. Here, in the present invention, the cylindrical battery is not limited to the nonaqueous secondary battery. Then, the other type of the cylindrical battery can be used, as long as it has an exhaust valve which is opened when the inner pressure becomes higher than the threshold pressure at the bottom plate.

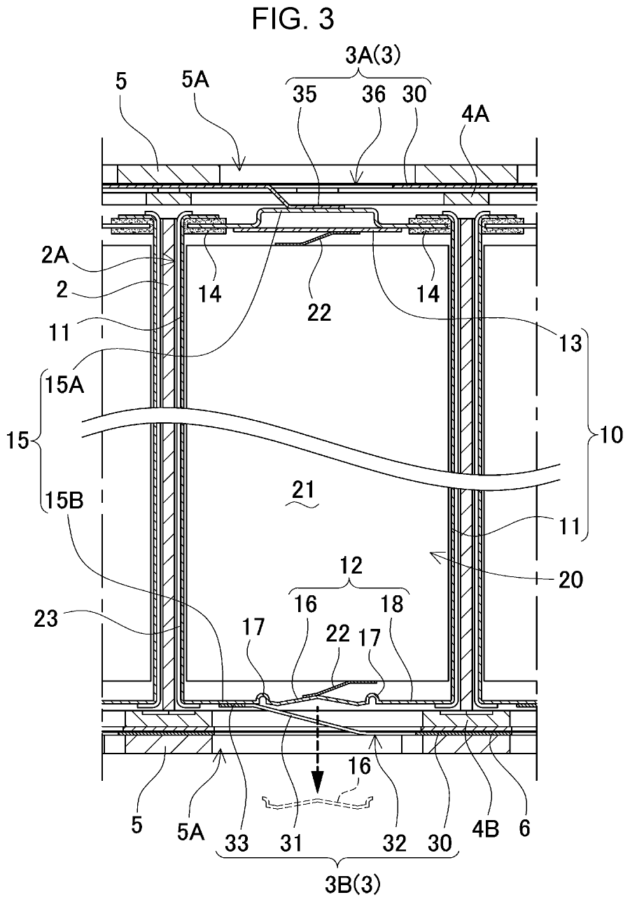

As shown in FIG. 3, spiral electrode assembly 20 is made by a process where positive and negative electrode plates 21 are stacked and wound with separators. The spiral electrode assembly 20 and a nonaqueous electrolyte are stored or housed in battery can 10 made of metal. In battery can 10, bottom plate 12 closes a bottom surface of cylindrical outer can 11, and sealing plate 13 closes and seals a top opening portion of outer can 11. Sealing plate 13 is fixed to outer can 11 through insulating material member 14 in an airtight way and in an insulated state. Cylindrical battery 1 has electrodes 15 at both ends of a longitudinal direction. Cylindrical battery 1 of the lithium ion secondary battery includes projecting electrode 15A disposed at sealing plate 13 as a positive electrode, and bottom surface electrode 15B disposed at bottom plate 12 of outer can 11 as a negative electrode. Cylindrical battery 1 has a diameter of 18 mm and an entire length of 65 mm, and it is, so called, a type of “18650” of the lithium ion secondary battery. Then, cylindrical battery 1 can be also used which has a size similar to or bigger than this size in the lithium ion secondary battery.

In cylindrical battery 1, housed spiral electrode assembly 20 are connected to projecting electrode 15A of sealing plate 13 and bottom surface electrode 15B of bottom plate 12 through inner tabs 22. Since it is not necessary to open a plurality of exhaust valves simultaneously as conventional, inner tab 22 which connects bottom surface 15B to spiral electrode assembly 20, can have a strength of which inner tab 22 is broken by opening exhaust valve 16. A metal plate or a metal foil thinner than bottom plate 12, or a fine conductive wire is used as inner tab 22. In cylindrical battery 1 shown in the sectional view of FIG. 3, inner tab 22 is connected to the center of bottom plate 12 by welding.

Since inner tab 22 is broken or separated in a state of the open valve of exhaust valve 16, exhaust valve 16 can be opened widely. Here, inner tab 22 does not necessarily need to be the strength of which inner tab 22 is broken or separated in a state of the open valve of exhaust valve 16. Inner tab 22 which is not broken or separated, is deformed by opening exhaust valve 16 pulling. Then, as inner tab 22 is loosely connected to exhaust valve 16, inner tab 22 is stretched or drawn linearly without separating in a state of the open valve of exhaust valve 16.

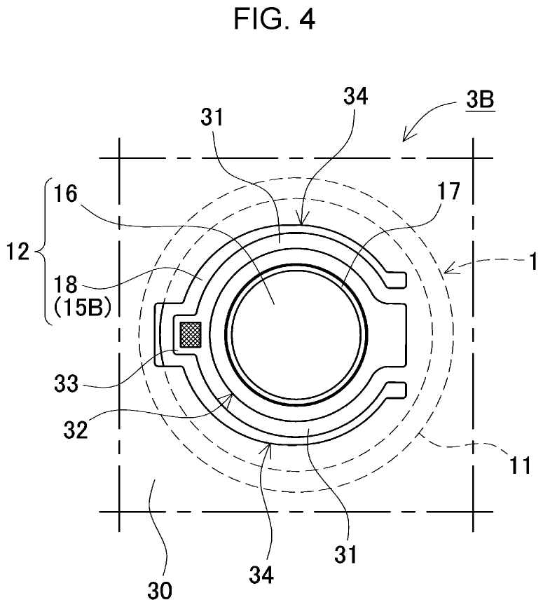

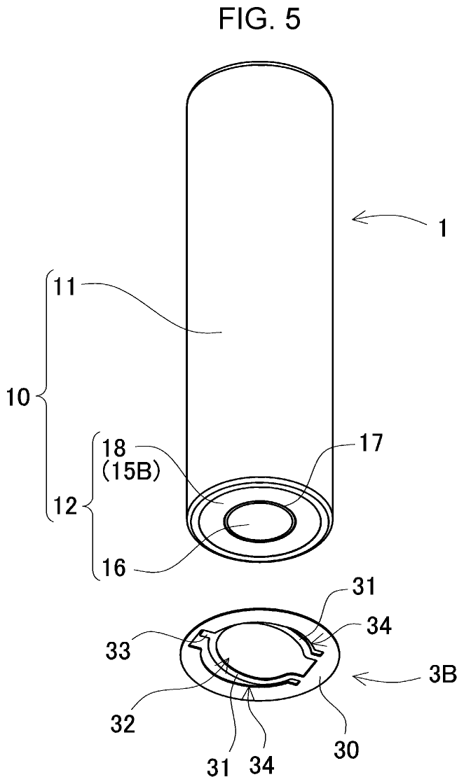

Ring-shaped thin-walled line 17 which breaks at a threshold pressure is provided in bottom plate 12, and the inside of thin-walled line 17 forms one piece of exhaust valve 16. In cylindrical battery 1 shown in the bottom surface view of FIG. 4 and the perspective view of FIG. 5, circular ring-shaped thin-walled line 17 is disposed concentrically to circular bottom plate 12, and thereby circular exhaust valve 16 is formed. Exhaust valve 16 is opened by thin-walled line 17 breaking. Exhaust valve 16 which is opened by thin-walled line 17 breaking, is separated from bottom plate 12. The threshold pressure of exhaust valve 16 is specified by the material of outer can 11 and the thickness of thin-walled line 17. Outer can 11 is made of iron, and the thickness of thin-walled line 17 is, for example, 30 μm to 100 μm. Circular thin-walled line 17 is made by press work at bottom plate 12 of outer can 11.

In cylindrical battery 1 of FIG. 3, a cylindrical portion of battery can 10 and a peripheral edge of bottom plate 12 are covered and insulated by insulation tube 23. Insulation tube 23 is a heat shrink tube, and also covers a peripheral portion of sealing plate 13 to insulate it. In bottom plate 12, there is a ring-shaped gap between insulation tube 23 and thin-walled line 17, and bottom surface electrode 15B is disposed at this gap. Bottom surface electrode 15B is disposed at the outside of thin-walled line 17, and at flat surface portion 18 of the inside of insulation tube 23.

In bottom plate 12 of FIG. 3, thin-walled line 17 is disposed, and thereby exhaust valve 93 is made at the inside of thin-walled line 94. Thin-walled line 17 is provided by making bottom plate 12 thin in a line shape through press work. In bottom plate 12, flat surface portion 18 is provided between thin-walled line 17 and the peripheral edge of bottom plate 12. In bottom plate 12 shown in the sectional view of FIG. 3, thin-walled line 17 has a U-shaped cross-section which projects inside outer can 11. Exhaust valve 16 is conical, and has a mountain shape of which the center projects inside. In FIG. 3, the boundary portion of exhaust valve 16 to thin-walled line 17 projects on the outer side than flat surface portion 18 which is disposed at the peripheral portion of bottom plate 12. Inner tab 22 coupled to spiral electrode assembly 20, is connected to the center portion, that is, the projecting portion of the mountain shape of exhaust valve 16. In exhaust valve 16 of the conical shape, there is a little distortion in a state where the inner pressure is applied, and thereby it can surely break the whole of thin-walled line 17.

In battery block 100 of FIG. 3, two sheets of lead plates 3 are disposed at both surfaces of battery holder 2. In battery block 100, one lead plate 3A is connected to projecting electrode 15A of cylindrical battery 1, and other lead plate 3B is connected to bottom surface electrode 15B which is disposed at bottom plate 12 of cylindrical battery 1, and cylindrical batteries 1 are connected in parallel.

Lead plates 3 is respectively made of a thin metal board, and are connected to electrodes 15 which are disposed at both edges of each of cylindrical batteries 1. one lead plate 3A is connected to projecting electrode 15A by spot welding, and other lead plate 3B is connected to bottom surface electrode 15B by ultrasonic-welding. In the ultrasonic-welding, the ultrasonic horn is pressed to the surface of lead plate 3B, and lead plate 3B is ultrasonically vibrated in a state where lead plate 3B is pressed to bottom surface electrode 15B, and lead plate 3B is coupled to bottom surface electrode 15B. In the ultrasonic-welding, lead plate 3B is ultrasonically vibrated in a direction parallel to the surface of bottom surface electrode 15B, and is connected to bottom surface electrode 15B. As lead plate 3 is connected to bottom surface electrode 15B by bonding the molecules of metals at the boundary face in the ultrasonic-welding, different kinds of metals are stably connected. Accordingly, lead plate 3B made of aluminum can be fixed to bottom plate 12 made of iron surely and stably.

However, in the present invention, the connection of lead plate 3 and electrode 15 of cylindrical battery 1, is not limited to spot welding or ultrasonic-welding. That is the reason why those are connected by using the optimal method for materials of the lead plate and the electrode. Accordingly, the lead plate can be connected by all of connecting structures or methods other than the above-mentioned connecting structure or method, for example, laser welding, soldering, or the like.

The stress is applied when the relative position of lead plate 3 to cylindrical battery 1 is shifted. Since lead plate 3 of the thin metal is easily resiliently deformed, the stress of lead plate 3 caused by the relative position shift to cylindrical battery 1, can be made small. Accordingly, lead plate 3 connected to electrode 15 is the thin metal plate having the thickness of, for example, 100 μm or more to 500 μm or less, preferably 100 μm or more to 300 μm or less. As the thin metal plate is easily resiliently deformed, lead plate 3B can be stably ultrasonically welded to bottom surface electrode 15B with a small output power. As the output power of the ultrasonic vibrator can be made small, the damage of thin-walled line 17 in the ultrasonic-welding process can be decreased.

Lead plate 3 of the thin metal plate has a high electric resistance. In battery block 100 of FIGS. 2 and 3, current collecting plate 5 is stacked on lead plate 3 to make the electric resistance small. Current collecting plate 5 is thicker than lead plate 3, and is an aluminum plate having a thickness of, for example, approximately 2 mm. Here, current collecting plate 5 can be the aluminum plate having a thickness of 1 mm or more, preferably 1.5 mm or more. Lead plate 3 and current collecting plate 5 are respectively aluminum plates, and lead plate 3 is connected to current collecting plate 5, and in battery block 100, lead plate 3 and current collecting plate 5 constitute a connecting lead, and such a connecting lead can be reduced in weight. Especially, by using the thick aluminum board as current collecting plate 5, while the electric resistance of current collecting plate 5 is decreased, it can be reduced in weight. Here, lead plate 3 and current collecting plate 5 can be respectively made of a metal board other than the aluminum board, for example, copper, nickel, iron, or an alloy of these metals. Further, as the property of the metal is improved by adding a different kind of metal, the word of “metal” is used as the meanings including its alloy in this specification. Accordingly, for example, the aluminum board is used as the meanings including aluminum alloy board.

One lead plate 3A is connected to projecting electrode 15A by spot welding. In lead plate 3A, as shown in FIGS. 2 and 3, connecting board 35 coupled to main body portion 30 is connected to projecting electrode 15A. Lead plate 3A shown in FIGS. 2 and 3, opens coupling hole 36 at a location corresponding to electrode 15 of cylindrical battery 1, and is provided with connecting board 35 connected to electrode 15, at a location of this coupling hole 36. These coupling hole 36 and connecting board 35 are made by punching the aluminum board. In one lead plate 3A, connecting board 35 is connected to projecting electrode 15A by spot welding.

As shown in FIGS. 3 to 5, other lead plate 3B connected to bottom surface electrode 15B, includes through hole 32 at a location facing exhaust valve 16. Through hole 32 of other lead plate 3B is made by punching the aluminum board. The size of through hole 32 is larger than the outer size of exhaust valve 16, and through hole 32 has a shape through which exhaust valve 16 separated from bottom plate 12 can pass, as shown by a chain line in FIG. 3. In order that exhaust valve 16 can smoothly pass through through hole 32, the diameter of through hole 32 is bigger than the outer diameter of exhaust valve 16, for example, by 0.5 mm or more, preferably 1 mm or more, more preferably 2 mm or more.

Other lead plate 3B connected to bottom surface electrode 15B includes resilient arms 31, and these resilient arms 31 are coupled to bottom surface electrode 15B. As shown in FIGS. 4 and 5, one end of resilient arm 31 is coupled to main body portion 30 of other lead plate 3B. Resilient arm 31 has an arch shape which is elongated along an inner edge of through hole 32, and is longer than a linear shape. Further, other lead plate 3B includes a pair of resilient arms 31 which are disposed at both sides of through hole 32. The pair of resilient arms 31 include connecting portion 33 which connects end portions (at a left side in the figure) on the side opposite to a connecting end where the pair of resilient arms 31 are connected to main body portion 30 of other lead plate 3B, and connecting portion 33 is coupled to bottom surface electrode 15B. Here, In FIG. 4, the coupling portion of connecting portion 33 and bottom surface electrode 15B is shown by cross hatching. Other lead plate 3B is provided with slit 34 disposed between resilient arms 31 and main body portion 30 such that resilient arms 31 are resilient. Slit 34 and through hole 32 are made by punching the aluminum board. In other lead plate 3B shown in FIG. 4, in order to make connecting portion 33 wide, slit 34 has a U-shape at the outside portion of connecting portion 33 of resilient arms 31, and wide connecting portion 33 is provided at the inner side of the U-shape.

Current collecting plates 5 are respectively stacked outside lead plates 3, and connected to lead plates 3. In order to connect to electrodes 15 of cylindrical battery 1, current collecting plates 5 respectively open connecting holes 5A at locations corresponding to electrodes 15 of cylindrical battery 1. In a state where current collecting plate 5 is stacked outside lead plate 3, lead plate 3 is spot-welded or ultrasonic-welded to electrode 15 through this connecting hole 5A.

### INDUSTRIAL APPLICABILITY

The battery block of the present invention, is a battery block where a plurality of cylindrical batteries each having an exhaust valve are connected by lead plates. The battery block can be suitably used as a power source which provides power to a driving motor of electric vehicles, for example, such as, hybrid cars, or electric cars, or a power source of stationary electric power storage facilities.

### REFERENCE MARKS IN THE DRAWINGS

100 battery block
1 cylindrical battery
2 battery holder
2A holding hole
3 lead plate
3A one lead plate
3B other lead plate
4A insulation holder
4B insulation holder
5 current collecting plate
5A connecting hole
6 insulation sheet
10 battery can
11 outer can
12 bottom plate
13 sealing plate
14 insulating material member
15 electrode
15A projecting electrode
15B bottom surface electrode
16 exhaust valve
17 thin-walled line
18 flat surface portion
20 spiral electrode assembly
21 electrode plate
22 inner tab
23 insulation tube
30 main body portion
31 resilient arm
32 through hole
33 connecting portion
34 slit
35 connecting board
36 coupling hole
81 cylindrical battery
82 sealing plate
82A upper metal plate
82B lower metal plate
83 exhaust valves 83
84 projecting electrode
85 coil spring
86 valve member
87 through hole
88 small hole
91 bottom plate
92 bottom plate
93 exhaust valve
94 thin-walled line
95 inner tab
96 rib

1. A battery block, comprising:
a plurality of cylindrical batteries of each of which the two ends are formed as positive and negative electrodes; and
lead plates which are connected to the electrodes of the cylindrical batteries,
wherein the cylindrical batteries are provided with battery cans having exhaust valves and bottom surface electrodes provided to bottom plates,
thin-walled lines ring-shaped which break at a threshold pressure are provided in the bottom plates,
insides of the thin-walled lines form the exhaust valves,
the bottom surface electrodes are provided further outside than the thin-walled lines,
one of the lead plates is connected to the bottom surface electrodes, and
the one of the lead plates connected to each of the bottom surface electrodes has a through hole of an internal shape through which each of the exhaust valves which separates from the bottom plates, passes, provided in a position facing each of the exhaust valves.

2. The battery block according to claim 1, wherein,
the one of the lead plates connected to each of the bottom surface electrodes, is connected to each of the bottom surface electrodes through a resilient arm of which one end is connected to main body portion of the one of the lead plates, and
the resilient arm has an arch shape which is elongated along an inner edge of the through hole.

3. The battery block according to claim 2, wherein
the one of the lead plates includes a pair of resilient arms which are disposed at both sides of the through hole,
the pair of resilient arms include connecting portion which connects end portions on the side opposite to a connecting end where the pair of resilient arms are connected to main body portion of the one of the lead plates, and
the connecting portion is connected to each of the bottom surface electrodes.

4. The power block according to claim 1, wherein,
a cylindrical portion of each of the battery cans and a peripheral edge of each of the bottom plates are covered with an insulation tube,
each of the bottom surface electrodes is disposed between the insulation tube and each of the thin-walled lines.

5. The power block according to claim 1, wherein,
the one of the lead plates is connected to each of the bottom surface electrodes by ultrasonic-welding.

6. The power block according to claim 1, wherein,
an inner tab which is connected to an electrode plate housed in each of the battery cans, is welded to an inner surface of each of the exhaust valves,
the inner tab is a metal plate thinner than each of the bottom plates from which each of the exhaust valves separates in a state of a broken valve.

7. The power block according to claim 1, wherein,
the one of the lead plates connected to each of the bottom surface electrodes, in a metal plate having a thickness of 100 μm or more to 500 μm or less,
the metal plate is made of any one of aluminum, copper, nickel, iron, or an alloy of these metals.

8. The battery block according to claim 7, wherein,
a current collecting plate is connected to the one of the lead plates connected to each of the bottom surface electrodes, and
the current collecting plate is thicker than the one of the lead plate.

9. The power block according to claim 1, wherein,
each of the cylindrical batteries is a nonaqueous secondary battery.
